(19) United States
(12) Patent Application Publication
(10) Pub. No.: US 2013/0302847 A1
(43) Pub. Date: Nov. 14, 2013

(54) METHOD AND SAMPLE SUPPORT TO ASSIST THE MANUAL PREPARATION OF SAMPLES FOR IONIZATION WITH MATRIX-ASSISTED LASER DESORPTION

(71) Applicant: Guido Mix, Achim (DE)

(72) Inventor: Guido Mix, Achim (DE)

(73) Assignee: BRUKER DALTONIK GMBH, Bremen (DE)

(21) Appl. No.: 13/990,582

(22) PCT Filed: Nov. 23, 2011
(86) PCT No.: PCT/EP2011/070838

§ 371 Date: Jul. 29, 2013

(30) Foreign Application Priority Data
Nov. 30, 2010 (DE) 10 2010 052 975.3

(51) Int. Cl. G01N 1/28

(52) U.S. Cl. CPC G01N 1/28
USPC 435/29; 73/863.01

(57) ABSTRACT

The invention relates to a method to assist with the manual preparation of a sample support for ionization with matrix-assisted laser desorption where a sample support with sample sites is provided, a selected sample site is highlighted in a way which can be perceived by the human eye at least with respect to neighboring, not selected sample sites, a sample is manually deposited on the selected and highlighted sample site, and the deposition state of at least the selected and highlighted sample site is determined. The method enables the sample preparation and sample analysis to be made more efficient and more certain.

### FIELD OF APPLICATION

The invention relates to a method to assist the manual deposition of samples and a method for determining the deposition of a sample site on a sample support for ionization with matrix-assisted laser desorption. The invention relates furthermore to a sample support suitable for these purposes. The invention also discloses a method for determining the sample quantity which is deposited onto a sample site of a sample support for ionization with matrix-assisted laser desorption.

### PRIOR ART

A simple and low-cost method for the mass spectrometric identification of microorganisms which is based on MALDI time-of-flight mass spectra (MALDI=matrix-assisted laser desorption and ionization) is now usually used for routine work in clinical microbiology. Microorganisms, which are also called germs or microbes, are usually microscopically small living organisms which are taken to include bacteria, fungi (e.g. yeasts), microscopic algae, protozoa—e.g. plasmodia, which cause malaria, for example—but also viruses.

Clinical microbiology is particularly concerned with the detection of pathogens of infectious human diseases. This detection is supplemented, if required, by an investigation of which antibiotic could be effective against a detected pathogen. Many microorganisms can already be recognized and characterized under the microscope. In most cases, however, they have to be grown in colonies under laboratory conditions in order to be precisely characterized. Feared pathogens of classic diseases, such as plague, typhoid or diphtheria, are today of little significance in routine clinical work. However, although great efforts have been made, even known infectious diseases such as tuberculosis have not completely disappeared from the developed world. A person's immune defense can be weakened as a consequence of previous illnesses, therapeutic measures or old age. Under these conditions, even microorganisms which are usually harmless for a healthy person can become dangerous pathogens. The totality of the microorganisms existing in a country is also subject to constant change because pathogens from far-away countries are introduced by population migration and long-haul tourism. The relevant detection methods have also to respond to such “new arrivals”.

Mass spectrometric identification starts with small quantities of microorganisms, usually cultivated in a culture dish, such as a Petri dish with a nutrient medium such as agar, but also in blood cultures or broth cultures, for some hours—usually overnight culture—or days. The aim is that the organisms grown in the nutrient medium each contain only one single species of microorganism, i.e. they are a pure culture. For the preparation of mass spectrometric samples from a culture plate, biological material of a single colony is usually manually taken from a nutrient medium with an inoculation swab and transferred to a sample site of a MALDI sample support. Conventional MALDI sample supports have between 16 and 384 spatially separate sample sites. The range can also extend from 6 to 1536 sample sites, however. After the biological material has been air-dried, a matrix solution is added. The organic solvent in which the matrix substance is dissolved usually destroys the transferred cells. This releases molecular cell components from the interior of the cell, especially soluble proteins, which are present in a high concentration. These cell components represent the analyte substances, targets for the subsequent mass spectrometric analysis. During a second air-drying, the organic solvent evaporates and the matrix substance crystallizes. In the process, the molecular cell components released are incorporated into the polycrystalline matrix layer. New inoculation swabs are used for the preparation of further sample sites on the MALDI sample support each time in order to prevent cross-contamination between individual colonies.

The liquid form of the matrix solution requires the technician to apply a high degree of concentration and accuracy in order to wet only those sites on the sample support with the matrix solution which have previously been deposited with a sample of the colony. A deposited quantity sufficient for a mass spectrometric analysis which consists only of biological material of a microorganism is usually not visible to the eye. The manual deposition of the biological material and the matrix solution can be assisted by marking the specific areas on the sample support which are destined for the deposition, in the form of depressions (known as “wells”), for example, as are familiar from microtitration plates. As an alternative, it is possible to make the sample sites hydrophilic and the surrounding areas hydrophobic. Small incorrect depositions, which are laterally slightly misaligned from their intended location, for example, are corrected by the matrix solution being pushed from the hydrophobic into the hydrophilic section. Nevertheless, with the manual deposition of liquid substances, uncertainties remain with regard to their deposition site and the distribution of the biological material at the deposition site (or the surface to be wetted). Taking into account the evaporation of the solvent and the crystallization of the matrix substance into which the analyte molecules are embedded, there remains a residual uncertainty which cannot be reduced at will, especially with respect to the sample quantity.

After the sample deposition and preparation is complete, the MALDI sample support is introduced into a MALDI time-of-flight mass spectrometer, where the sample sites are bombarded with laser pulses. In this way, the molecular cell components embedded in the matrix layer are desorbed and ionized together with the matrix substance. The ions are accelerated in an electric field and impact on a detector after mass-dependent times of flight. The times of flight measured with the detector are converted into mass-to-charge ratios m/z with the aid of known calibration functions. The majority of the measured signals originate from soluble proteins, such as ribosomal soluble proteins, which are specific to the species of microorganism and sometimes even to the strain. The mass spectrum can therefore be interpreted as a molecular fingerprint and can thus be used for a microbial identification.

In recent years, methods have been developed with which the laser spot on the sample support can be spatially controlled. In some of these methods, the prepared sample support is optically imaged with incoherent light and evaluated with respect to the exact location of the sample substance on the sample support in order to differentiate between spotted and unspotted sites. The latter should not be scanned by the laser for desorption.

Publication EP 1 739 719 A2, for example, relates to an imaging method for a sample support which is used with an ion source for matrix-assisted laser desorption within the vacuum stage of a mass spectrometer. In order to eliminate the problem which occurs when an area such as the surface of the sample support is optically imaged from one angle only, namely that only a limited region of the image is in focus and other areas have a worse resolution in comparison, it is proposed that several images with different focal areas on the sample support are recorded, and that these are collated by a special imaging method to produce an overall image of the sample support which is in focus over a large area. The overall image is intended to identify the sample sites on the sample support which have been spotted with a sample, and to point the laser beam onto the areas where one can expect sufficient analyte substance for a measurement.

The knowledge about certain spotted areas on the sample support alone is often too imprecise a criterion for the quantity of ions which is supplied by desorption of these spotted areas. It is apparent that, despite a mode of operation where the laser covers only areas which have been identified in advance as being spotted, the measurements often have insufficient signal strength, i.e. the mass signals—ion current peaks as a function of the mass-to-charge ratio m/z—do not rise far enough above the ever-present background to provide a certain identification of the components of the microorganisms. In addition, a quantity of analyte can be concentrated at one location to such a degree that—after sample desorption—the usual ratio between analyte molecules and matrix molecules (around 1:10,000) no longer exists in the subsequent mass spectrometric analysis, or even that the acquisition of the mass spectra is disturbed by space charge effects. In the usual case, where the ions are detected with a secondary-electron multiplier (SEM), too many ions per unit of time, caused by an excess of desorbed sample, can additionally cause saturation effects. These effects impede the measurement with a mass spectrometer.

There is a need to make the process of deposition and preparation of samples on a sample support, the assignment of the samples to the sample sites on the sample support, and the sample analysis more efficient and more certain, particularly in the preparation of samples of microbial origin for the identification and characterization of microorganisms.

There is, furthermore, a need to provide the user with a criterion for deciding whether or not prepared samples on a sample support are suitable for a mass spectrometric analysis in order to be able to undertake a further preparation of a sample, where necessary, and avoid unnecessary measurement procedures.

### DESCRIPTION OF THE INVENTION

A method is suggested which assists with the manual preparation of a sample support for ionization with matrix-assisted laser desorption. The first step is to provide a sample support containing sample sites. A selected sample site is highlighted in a way which can be perceived by the human eye at least with respect to neighboring, not selected sample sites. A sample is manually deposited on the selected and highlighted sample site. Finally, the deposition state of at least the selected and highlighted sample site is determined.

The visible highlighting assists a technician who is carrying out manual preparation of a sample support to deposit a sample taken from a nutrient medium, such as agar plates, broth or blood cultures at the correct sample site. The risk of deposition errors can thus be reduced. The highlighting here is particularly intended to be reversible, i.e. can be activated and deactivated, and can be reversed.

The sample site can be selected according to whether it is empty, deposited with an analyte substance or already prepared with a matrix substance. The method can thus be carried out at various stages of a deposition sequence. It is also possible to make a geometric selection specification, for example by specifying that only every n-th—e.g. every second—sample site is to be spotted. This may be useful if the risk of a cross-contamination by outgassing of a sample and transfer of the outgassed sample particles in the gas phase onto a different sample site is increased by the spotted sample sites being close together. In one version of the method, the selection can be carried out automatically by all unspotted sample sites being considered in a specific sequence, for example, or alternatively by a user of the method.

In a development of the method, several sample sites can be selected and the highlighting can be repeated in a deposition process, where with every repetition a different selected sample site is highlighted. This development is particularly suitable for the sequential processing of different samples which originate from different colonies on a nutrient medium and are to be applied to a sample support. With such sequential processing it is preferable to use a monitoring, control and registration system which assists the user of the method in selecting the samples to be transferred.

On the one hand, the method assists the technician carrying out the sample preparation to transfer the sample by highlighting the sample site to be deposited. On the other hand, the method allows a process control of whether or not the deposition has been sufficiently successful in terms of quantity and/or quality. If the determination of the deposition state identifies a deposition which satisfies the requirements, the highlighting can automatically be canceled. This procedure is particularly useful if a deposition sequence is to be carried out where, after each successful deposition of a selected sample site, the highlighting of the sample site is deactivated and the next selected sample site from a large number of selected sample sites is highlighted for the subsequent deposition procedure.

The work of a technician is particularly to be facilitated by the selection and the highlighting being carried out (semi-) automatically with electronically assisted means. The procedural effort can be minimized if the highlighting of the selected sample site is limited to the immediately adjacent ones which have not been selected. The highlighting effect can, however, be enhanced by increasing the number of not selected sample sites, in the extreme case such that the selected sample site is highlighted with respect to all other not selected sample sites.

The sample can comprise a solution with an analyte substance or a matrix substance, crystals of a matrix substance, cells of a microorganism or several microorganisms, dissolved cell components of a microorganism or several microorganisms, or any combination thereof. Samples can especially be microorganisms in untreated form, microorganisms lysed in a matrix—digested with a matrix substance, not on the sample support, but in advance—or proteins or protein chains extracted from the microorganisms in a solvent, which provide the actual mass signal of interest in the subsequent mass spectrometric analysis. The precise method sequence for a deposition on a sample site is not strictly specified, but can be selected to suit the circumstances. For example, it is possible to first deposit the microorganisms onto an empty sample site and to then wet them with a matrix substance as described in the introduction. In another version of the method, the matrix can first be deposited on an empty sample site and dried, followed by the microorganisms in a solvent. This causes the matrix to dissolve slightly and it incorporates the cell components of the microorganisms which are also digested by the solvent, such as proteins or protein chains, and embeds them into the matrix crystals during the drying process.

In the introduction above, MALDI is given as the preferred type of ionization, where ions are created by the desorption brought about by a laser. However, it is obvious that in the present invention, only the laser desorption for transferring the analyte substances into the gaseous phase is important. The type of ionization can be selected as required to suit the application. The laser desorption can be carried out with a chemical ionization (LDCI), for example, but other types of ionization can also be used. The term ionization with matrix-assisted laser desorption must be understood in a correspondingly broad sense.

Within the framework of the current application, deposition state is particularly meant to be a quantitative deposition state. The quantification can be a simple one by distinguishing between the states DEPOSITED and NOT DEPOSITED. In the simplest version, these two states of the “depositing state space” can then be applied separately to a deposition with individual sample substance types—for example deposited or not deposited with a matrix substance, analyte substance, solvent or the like. A more detailed differentiation of the description of the deposition state can be achieved if the quantity of the deposited sample is taken into account, as is explained below. The term deposition state is therefore to be understood in a correspondingly broad sense.

The selected sample site can be highlighted mechanically and/or with the aid of a light effect. The important criterion is that the highlighting marks the selected sample sites in such a way that the user of the method is able to recognize on which sample site a sample is to be deposited. This can be carried out mechanically, for example, by means of an adjustable pointer, whose tip can be pointed at the selected sample site. A further mechanical version comprises an acceptance element which allows manual access to a selected sample site and at least prevents access to neighboring, not selected sample sites. Furthermore, it is possible to illuminate the selected sample site. Generating an enhanced color and/or brightness contrast in comparison to surrounding, not selected sample sites enables the selected sample site to be particularly clearly marked.

In various embodiments the selected sample site is illuminated from above by a suitable light source, such as a spotlight, laser pointer or the like. Preferably, the light source is configured such that the angle of light incident on the selected sample site relative to the surface of the sample support is rather small, such as smaller than 30° or even smaller than 20° or even smaller than 10° or even smaller than 5°. In this manner, shadowing of the highlighted sample site brought about when a tip of a pipette or an inoculation swab approaches the highlighted sample site and crosses the light beam can be delayed up to a short time before the deposition so that the risk of a user being confused by the shadowing and thereby losing focus of the right sample site can be reduced.

In one embodiment, the sample support can be manufactured at least partially from a plastic which responds to voltages. The sample support can then be separated into several areas, each containing sample sites, which can be separately supplied with a voltage. Under the influence of the voltage, the corresponding area changes its light transmission properties, from partially transparent to opaque or vice versa, for example. In this way a brightness contrast can be generated without the need for a separate light source. Rather, in this example, the ever-present room light (in the laboratory) can be used to generate a light effect by changing the characteristics of the surface reflecting the light.

The light effect can additionally, or alternatively, be produced by light entering from the back of the at least partially transparent sample support. The location where the light enters then preferably corresponds to the position of the selected sample site on the surface of the sample support. A light source can be used for this purpose, for example, which is positioned at the back of the sample support and can be moved so that the different positions can be reached in order to illuminate the sample site. This embodiment can particularly reduce the space required for carrying out the method. Alternatively, a network of light sources can be used, where each light source is positioned at a location on the rear of the sample support which corresponds to the position of a sample site on the surface. Highlighting the selected sample site then only requires the corresponding light source to be activated.

The number of sample sites whose deposition state can be checked is freely selectable. The only prerequisite is that at least the selected and highlighted sample site is checked. In one embodiment, the selected and highlighted sample site is checked exclusively. In other versions, a certain number of not selected sample sites can be checked or, in the extreme case, all the sample sites on the sample support. The latter version has the advantage that a possible erroneous deposition on the sample support is detected with a high degree of certainty.

A notification or warning signal can be generated when a change of the deposition state is identified at a location other than the sample site selected and highlighted, and/or if a predetermined time has elapsed since the highlighting began without a deposition state change being detected. The technician can be made aware of a possible mistake with a notification or warning signal. The term notification or warning signal is to be understood in a broad sense. It can be an optical or acoustic signal which can be perceived directly by the user. In one version, the notification or warning signal can be generated in the form of an electronic message which is, for example, stored in an electronic laboratory log, stating the relevant circumstances—such as time, location, user, sample origin, coordinates on the sample support—and which is accessible for a subsequent evaluation or check.

The deposition state is preferably determined with the aid of an optical sensor system which has a processing and evaluation function which is used to detect movements and to spatially classify them. The optical sensor system can form a grid of monitoring beams over the sample sites of the sample support. A movement toward a sample site only interrupts certain monitoring beams and allows the beam interruption to be assigned to a sample site. Such a system can be realized with light barriers, for example. It is also possible to use a camera system for the detection of movements of a transfer element—such as rod, pipette, inoculating loop or swab—to a sample site, particularly in a direction parallel to the surface normal of the sample site. The camera system here should preferably be able to monitor the sample sites from different angles and also be equipped with a suitable image evaluation function. With such a camera system, the deposition state can be determined with the aid of a two- or three-dimensional optical image, for example.

By probing at least one chemo-physical property at a sample site, the deposition state can be determined by means of a change at least to this one chemo-physical property. The chemo-physical property is selected, in particular, from the group comprising resonance frequency of a piezoelectric material, density, geometric dimension, propagation time of ultrasonic or electromagnetic waves, electrical capacitance, electrical resistance, inductance, permittivity, magnetizability, light diffusion, light absorption, light reflection or luminescence.

The probing preferably takes place directly on the sample deposited onto the sample site. This increases the reliability of the determination of the deposition state, because deposited samples can be detected directly from the result of the deposition process. Probing the chemo-physical properties particularly avoids damage to the structural integrity of the sample. Instead, in a kind of remote sensing, the sample site—and thus the sample thereon—is probed in order to obtain measurement data. These measurement data can represent the chemo-physical property directly, but they can also serve to determine the chemo-physical property by means of a further evaluation. The probing can, furthermore, be carried out either with or without contact with the sample support. Contact probes act particularly on the back of the sample support, while non-contact probing techniques are preferably used on the (upper) surface of the sample support.

A change in the chemo-physical properties is detected in particular by comparing the values or the amplitudes of the chemo-physical property at the time of selection and highlighting and a time afterwards at the corresponding sample site.

In one version of the method, the sample quantity can be determined from at least one chemo-physical property, from the optical image, or from both. This evaluation can cause a notification or warning signal to be generated if the quantity of sample thus determined does not correspond to a predetermined target sample quantity. An informative mass-spectrometric measurement, with a sufficient signal-to-noise ratio in particular, can be obtained when the sample quantity at the sample site on the sample support, which represents the source for the ions to be detected, is in a sample quantity interval. The interval usually has an upper and a lower limit, on the one hand, and on the other hand depends in particular on the instrumentation which is used for the mass spectrometric analysis, and can preferably also be determined empirically, taking into account the saturation limit and/or space charge sensitivity. It can also be an interval which is upwardly open on one side, for example if a sample quantity which could lead to undesirable space charge and/or saturation effects in the mass spectrometric analysis can be virtually excluded. In addition to the method known from the Prior Art for selecting prepared areas on the sample support for a laser bombardment, this provides a further criterion which can be used to optimize the mass spectrometric analysis because sample sites on the sample support which have a quantity of sample, but whose yield is below the lower limit, or which are covered with too much sample, can be correspondingly labeled before the measurement and can be disregarded during the subsequent analysis. The deposition can be repeated if required. This creates time for the user of the method according to the invention to concentrate on measuring the samples which originate from sample sites with suitable sample quantities. The ratio of the processing and work needed in relation to the desired result in the form of informative and useful mass spectra can thus be improved.

The sample quantity can be determined in different stages of a deposition sequence with the aid of at least one chemo-physical property. If an analyte substance, for example microorganisms which originate from a colony on an agar plate, is applied first onto the sample site, the analyte quantity can be determined. If the matrix substance is then deposited onto the sample site—for example in liquid form including solvent—and then evaporated, the total quantity of sample can be determined as the sum of analyte quantity and matrix quantity. The matrix quantity can be obtained from this in turn by simply subtracting the analyte quantity determined earlier. An analogous procedure can be used if a matrix substance is applied first, followed by the analyte substance. This makes it possible to specify not only the sample quantity, but also its composition. This ratio of matrix to analyte substance can serve as a further criterion for deciding whether a spotted sample site is suitable for a laser desorption with subsequent mass spectrometric analysis.

In a simple version, the sample quantity can be determined by using an empirically obtained relationship according to which the sample quantity is preferably linked uniquely with a certain value of the chemo-physical property. Such empirical relationships can be determined in the laboratory and entered into an electronic evaluation system which analyzes and processes the measurement data. It is also possible to derive the sample quantity from the measured data of the chemo-physical property with the aid of higher chemo-physical relationships. These higher relationships can be derived from the crystal structure of a matrix substance, for example, in particular from the lattice structure.

The probing of one single chemo-physical property can be sufficient to obtain reliable information on the sample quantity of the probed sample. The determination of the sample quantity can be fundamentally made more precise if more than one chemo-physical property is probed. This can be undertaken sequentially or simultaneously if the different probing techniques do not interfere with each other. The time and effort required for the probing process can be selected by a user according to the benefit to be expected.

The chemo-physical property of the sample can be a measured property such as a geometric dimension—length, width or thickness of the sample, for example—and/or the density. The thickness of the sample can, for example, be sufficient for the determination of the quantity if the sample sites on the sample support take the form of wells. The volume of a sample quantity is then uniquely linked to the level of sample in the well. In one version, the area which the sample occupies on the—flat, for example—sample support can be used as a measurement property. The density particularly means the mass density, which can be related to the crystal structure of the matrix substance in a particularly advantageous way for the evaluation.

The one or more chemo-physical properties are preferably probed by means of light, two- or three-dimensional image analysis, spectral analysis, or ultrasound. Ultrasonic waves can be sent through the sample support in a preferred way from the back of the sample support, which is on the opposite side from the sample sites. By evaluating the signals reflected at the boundary surfaces, particularly measuring the propagation time, a change in the deposition status can be determined, and the thickness can be derived from the propagation time and the speed of sound. In an optical version, a test beam can be directed onto the sample site, and the reflected light, for example its intensity or spectral distribution, can be used to derive chemo-physical properties at the sample site or the sample arranged thereon in order to determine the deposition state.

Furthermore, the electrical capacitance, electrical inductance or both can serve as the chemo-physical property of the sample. These properties are also significantly determined by the crystal structure of a matrix substance, for example, and are changed in a characteristic way by the embedding of different types of analyte substances, for example the above-mentioned proteins of microorganisms. Particularly advantageous is the probing of these electrical properties of the sample if it is referenced to the corresponding electrical properties of the sample support—in particular its material and shape.

The chemo-physical property can be probed by currents, voltages or both which are induced in or at the sample site—and thus on or in the sample. The plural of current and voltage is used here only to simplify the linguistic expression. It is also possible to induce one electric current or one voltage in or at the sample site—and thus on or in the sample. The use of the plural must not be understood in a limiting sense here.

Additionally, the objective is achieved by the following method for the manual preparation of a sample on a sample support for ionization with matrix-assisted laser desorption: A sample is provided, to which an identification tag has been assigned. Furthermore, a sample site on the sample support, provided with a further identification tag, is highlighted in accordance with one of the above-described methods, and a sample is deposited. The identification tags are assigned to each other and stored. Thus, after the end of the deposition process of the sample support, it is possible to trace back and assess which samples with which origin have been transferred onto a specific sample site. This allows a subsequent process control and can, for example, show up an error if a sample of particular origin was deposited on two sample sites, although for each sample from the origin in question only one sample site was intended. The assignment and storage can be carried out in a combined method step jointly or separately. The assignment can be carried out before the actual deposition process, for example, and the storage after the conclusion of the deposition process. A specific temporal sequence of the assignment and the storage during the method is not mandatory. It is preferable, however, to assign and store the identification tags after the deposition process, because in this way an incorrect assignment or incorrect deposition can be more easily identified.

The identification tag of the sample can be derived from the labeling of the sample vessel—a Petri dish, for example—from which the sample originates. It can be a barcode which can be optically scanned, or a sequence of signals stored in an RFID chip which can be accessed via radio signal (RFID—radio frequency identification). This gives a high degree of traceability for the sample. It is also possible to generate or supplement an identification tag by using a camera to take a picture of the sample source, in particular the flat nutrient medium in a Petri dish, and determining the coordinates of the sample origin in the image and assigning it to the sample. With this information, the identification tag of the nutrient medium carrier, such as the Petri dish, can be supplemented per sample or colony and thus specified in more detail. As an addition or alternative to an optical image of the flat nutrient medium, the sample origin can be identified on the basis of the change in capacitance measured on the flat nutrient medium before and after the sampling. The identification tag of the sample site can be specified with data on the deposition state. This procedure makes it possible to store the site information together with the information as to whether the sample site is deposited or not deposited, how large the sample quantity is, or whether the sample site is suitable as an ion source for a mass spectrometric analysis.

In one version, the sample origin data or the identification tags can be transmitted to the sample preparation instrumentation via telecommunications equipment in order to be stored there together with the deposition coordinates or the identification tags of the sample site on the sample support after completion of the deposition of a sample site on the sample support. It is thus possible to undertake a particularly detailed sample trace-back.

The objective is also achieved by a method for determining the deposition state of a sample site on a sample support for ionization with matrix-assisted laser desorption, where, after a sample has been deposited, at least one chemo-physical property is probed at the sample site, and the deposition state is determined by a change in at least one chemo-physical property. The one or more chemo-physical properties come from the group comprising resonance frequency of a piezoelectric material, propagation time of ultrasonic or electromagnetic waves, electrical capacitance, electrical resistance, inductance, permittivity, magnetizability, light diffusion, light absorption, light reflection or luminescence.

The objective of the invention is also achieved by a method for determining the sample quantity applied to a sample site of a sample support for ionization with matrix-assisted laser desorption, where the three-dimensional distribution of a sample deposited on the sample site is determined by at least one of the following optical surface-measuring techniques: holography, interferometry, speckle-pattern interferometry, fringe projection, laser triangulation or laser scanning. With a fringe projection method as described in the document DE 10 2007 006 933 A1, for example, whose content is deemed to be part of the disclosure of the present invention, height differences on the surface of the sample support can be determined with a high degree of accuracy. When these height differences are probed in two dimensions, the volume of the deposited sample can be determined, from which in turn the sample quantity can be derived.

The objective is also achieved by the provision of a sample support for ionization with matrix-assisted laser desorption which is particularly suitable for use in one of the methods described above. It is characterized by a sensor for a chemo-physical property which is integrated at a sample site of the sample support.

The integration of the sensor into the sample support at a sample site means that no separate arrangement above the surface of the sample support is required in order to determine the deposition state. Instead, the sample support is provided with a compact device which leaves room for maneuvering the other instruments for sample support deposition and sample support analysis. The sample support has connections to supply the sensor with power, where necessary. Alternatively, a power source—a battery, for example—can also be integrated into the sample support. The sample support can furthermore comprise an interface for data transmission, via which control signals are transmitted to the sensor in order to initiate the determination of the deposition state. The data thus determined can be transmitted to an evaluation unit via the interface, can be used for the collation of a deposition state plan, and can be correspondingly visualized. The transfer or transmission of the signals can be performed via connecting lines or can also be wireless. It is preferable if the sample support is provided with a holder which has complementary connections which are correspondingly adapted to the connections and/or the interface connections on the sample support. Wireless trans-mission can be set up with familiar telecommunication means such as Bluetooth, infrared or any other interface.

The singular form of the term sensor is used here to simplify the linguistic expression. It is also possible to provide all sample sites with a suitable sensor in order to obtain a comprehensive image of the deposition state of the sample support. The term sensor is to be understood in a broad sense and can also comprise a grid of measuring locations, for example. This can be realized with, for example, electrical conductors in the form of wires arranged on the surface of the sample support so as to cross each other in such a way that the electrical conductors have intersections at the sample sites at least. The conductors must be insulated from the surrounding sample support material if this is also conductive. If a sample lies on a sample site, and thus also on some of the intersections arranged there, the sample material changes the electrical properties of the conductors concerned. By supplying the grid with test voltages, these changes in the electrical properties can be detected and localized on the sample support, and thus they can be assigned to a sample site from the matrix of sample sites.

Correspondingly, there are a large number of properties to which a sensor may respond, for example the resonance frequency of a piezoelectric material, the electrical capacitance, the electrical resistance, the inductance, the magnetizability, the light diffusion, the light absorption, the luminescence or any combination thereof. Of course, the sample support can also have several sensors to detect more than one of the properties stated.

To measure the properties, the sensor can take the form of a transistor, in particular a metal oxide semiconductor field effect transistor, a resistor in a Wheatstone bridge, a resistor of a resistance grid, a quartz microbalance, a photosensor, a pressure sensor as used in touchscreens, or any combination thereof.

In a further embodiment, the sample support can have a memory for the assignment and recording of identification tags of samples and sample sites. The assignments made are securely stored there and can be queried as often as desired for a subsequent evaluation or check.

### DESCRIPTION OF THE FIGURES

In the following, the invention is explained in more detail with the aid of example embodiments in conjunction with the enclosed drawing. In the drawing:

FIG. 1 shows a flow chart of an embodiment of the method according to the invention to assist in the manual preparation of samples on sample supports for ionization with matrix-assisted laser desorption;

FIGS. 2a to 2f show example embodiments for means of highlighting;

FIG. 3a depicts an arrangement for the monitoring of a sample preparation on a sample support with the aid of an optical sensor system;

FIG. 3b depicts an arrangement for the optical determination of a deposition state of sample sites on a sample support with the aid of a camera system;

FIGS. 3c and 3d illustrate other arrangements for an optical determination of a deposition state of a sample site on a sample support using detection of scattered light;

FIGS. 4a to 4f show example embodiments for probing techniques for a chemo-physical property;

FIG. 5 shows a flow chart of an embodiment of a method according to the invention to determine the deposition state of a sample site on a sample support for ionization with matrix-assisted laser desorption;

FIG. 6 shows a flow chart of an embodiment of a method according to the invention to determine the sample quantity which is deposited on a sample site on a sample support for ionization with matrix-assisted laser desorption;

FIG. 7 depicts an example for an interferometric probing method to determine the three-dimensional distribution of a sample on a sample site;

FIG. 8 illustrates an example embodiment for a sample support according to the invention; and

FIG. 9 presents a flow chart of an embodiment of a method according to the invention for the manual preparation of a sample on a sample support for ionization with matrix-assisted laser desorption.

### PREFERRED EXAMPLE EMBODIMENTS

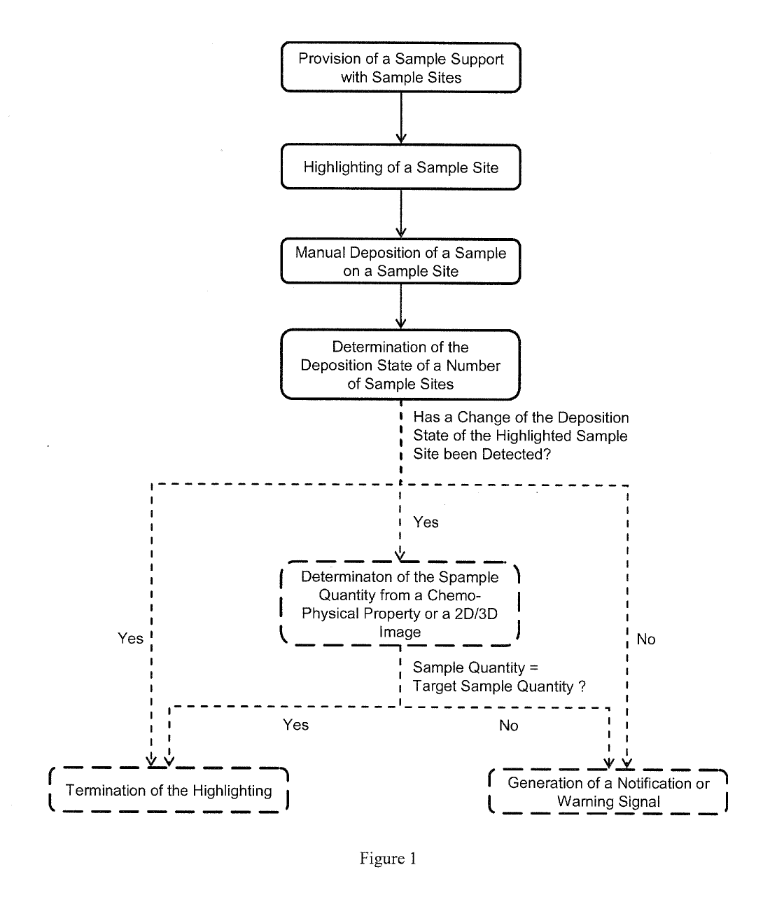

FIG. 1 depicts a flow chart of an embodiment of the method to assist with the manual preparation of a sample support for ionization with matrix-assisted laser desorption. In a first step, a sample support with sample sites is provided. A selected sample site is highlighted in a way which is visible to the human eye, at least with respect to neighboring, not selected sample sites, for example by illuminating it or directing a pointer. A sample is then manually deposited on the highlighted sample site. In the present example, the deposition state of at least the selected and highlighted sample site is then determined. As an option (shown dashed), the method can be linked to a query as to whether a change in the deposition state has taken place at the highlighted sample site. A change is particularly expressed in the fact that sample material has been deposited. If the correct sample site has been spotted, the highlighting can be finished. If not, the user can be informed of the erroneous deposition by a notification or warning signal. In a further optional version, a further query can be carried out after a change at the highlighted sample site has been identified. In this example, the sample quantity is detected using at least one chemo-physical property or a two- or three-dimensional image. The chemo-physical property can be the same as the one used for the detection of the deposition state. If the detected sample quantity corresponds to a predetermined target sample quantity, if it falls within a sample quantity interval, for example, the highlighting can be finished. If the detected sample quantity and the target sample quantity do not agree, the user can again be made aware by a notification or warning signal.

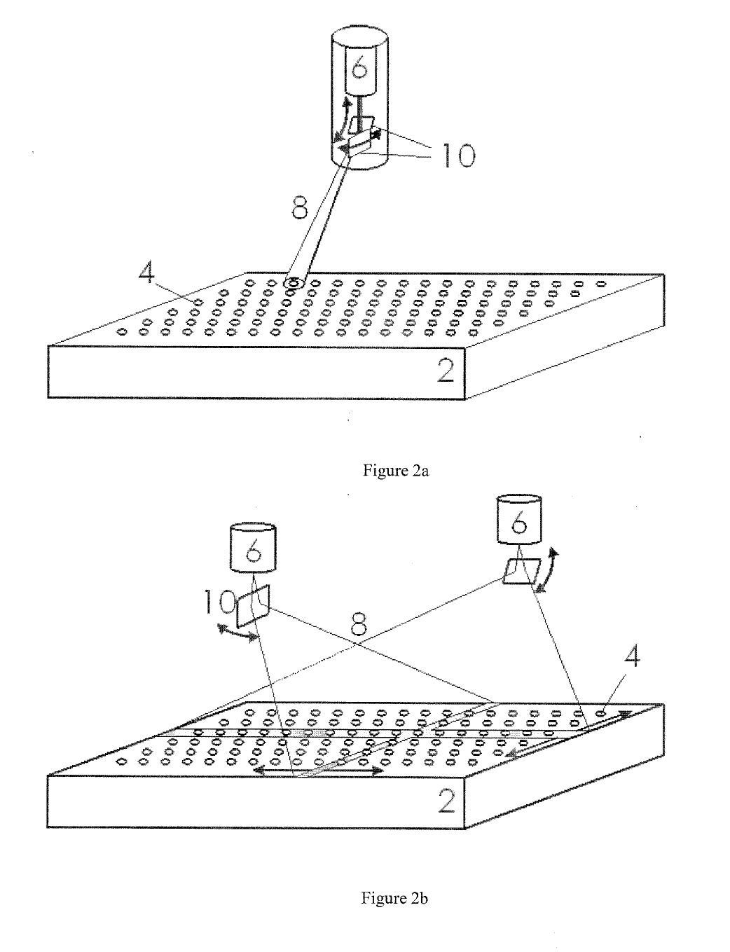

FIG. 2a shows an example embodiment for means of highlighting a selected sample site. The sample support 2 contains several sample sites 4 in a grid-like arrangement. The highlighting is achieved optically by means of a light effect. A light source 6 is arranged above the surface of the sample support 2 for this purpose. The light 8 emitted from this light source 6 can be directed onto the selected sample site by means of two adjustable deflection mirrors.

FIG. 2b illustrates a variant of the means of highlighting. There are two light sources 6, which each direct light 8 in the form of a light bar via deflection mirrors 10 onto the surface of the sample support 2. The light bars are arranged so that they intersect roughly at right angles and illuminate a column or a row of sample sites 4 in the sample location matrix 4. The relevant row or column can be selected by adjusting the mirrors 10. The intersection of the light bars marks the sample site 4 to be spotted for the technician. The eye of the technician is guided to the correct sample site by the elongation of the light bars, so to speak.

FIG. 2e depicts a further example embodiment for the means of highlighting. The sample support 2 in this example is at least partially or sectionally transparent. Several light sources, for example light emitting diodes 12, are arranged on the back of the sample support 2 in the form of a grid, where each light source is assigned to a sample site 4 on the surface of the sample support 2. For the highlighting, the light source assigned to the selected sample site can be activated. This causes light to enter the sample support 2 from the back at the corresponding position. The light 8 can pass through the sample support 2, possibly dimmed, and illuminates the area of the selected sample site on the surface of the sample support 2 in a way which is visible to the human eye. Alternatively, the light for the highlighting can also be made to enter the sample support 2 from the back by using a liquid crystal display 13 (FIG. 2d) which is positioned on the back of sample support 2. The liquid crystal display preferably has areas 15 of image elements which are uniquely assigned to a sample site 4 on the surface and can be controlled independently of each other for the purpose of lighting and therefore highlighting.

FIG. 2e shows a further example embodiment for the means of highlighting, in this case based on a mechanical principle. It comprises a movable pointer 14 with a tip 16. The tip 16 can be pointed toward every sample site 4 on the sample support 2, and highlights a selected sample site like a pointing finger in a way which is visible to the human eye. It is advantageous that other sample sites not selected by the pointer 14 are covered and are therefore not subject to the risk of an erroneous deposition.

FIG. 2f illustrates a further example embodiment for the means of highlighting on the basis of a mechanical principle. It comprises a mask with an opening which allows manual access to the selected sample site and prevents access to neighboring, not selected sample sites, and is depicted in the illustration as a perforated plate 18. The hole 20 can be positioned above every sample site 4 by means of a movement of the means of highlighting and the sample support 2 relative to each other.

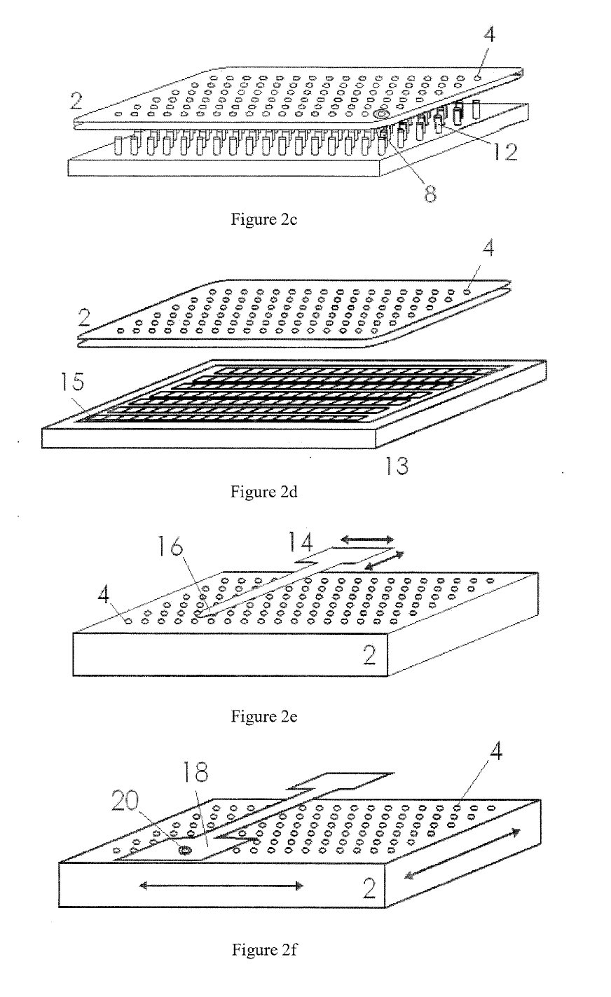

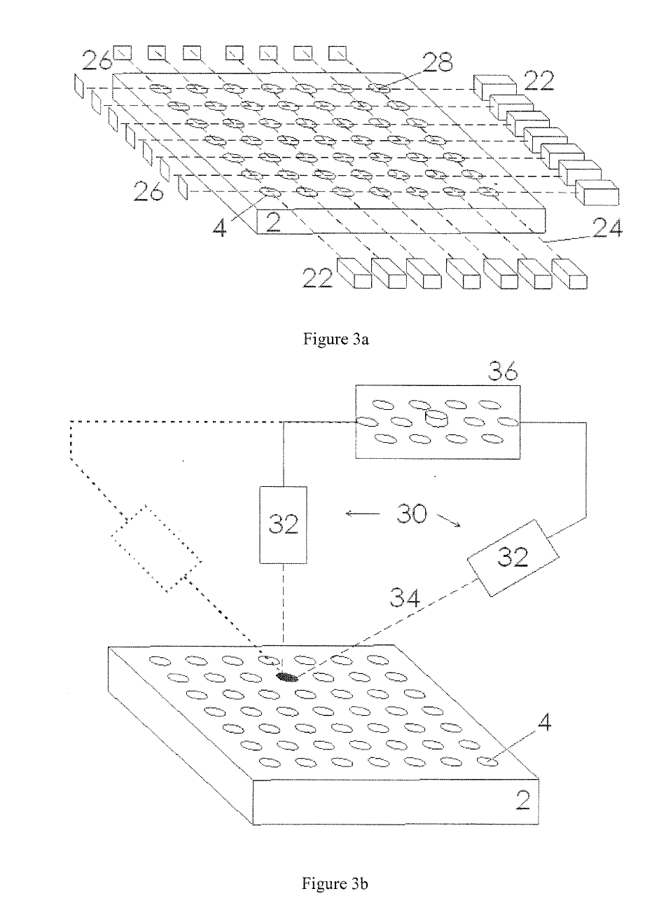

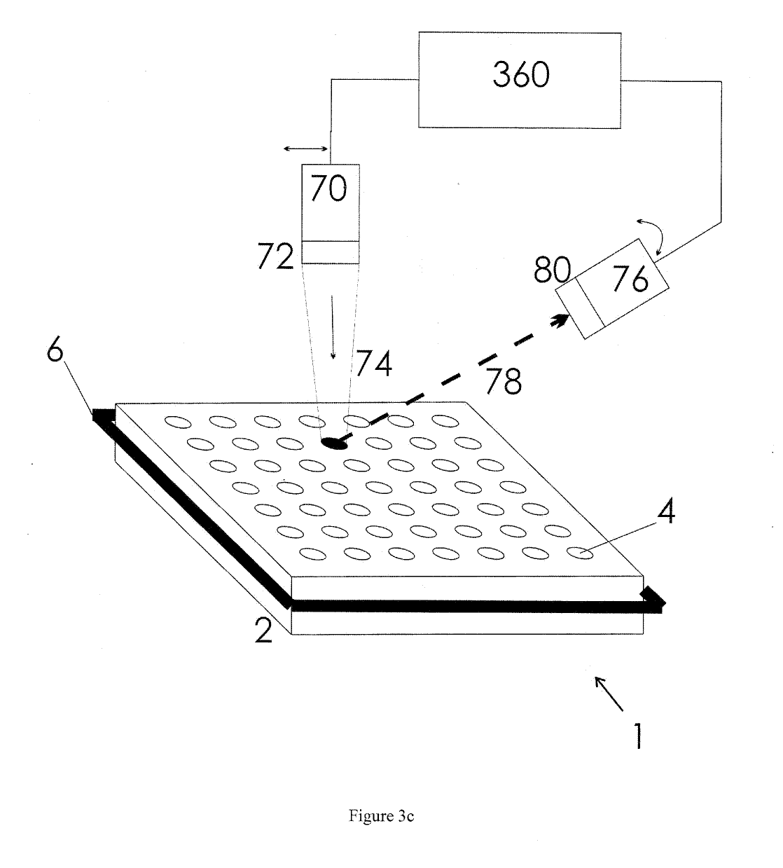

FIG. 3a shows an arrangement where an optical sensor system can be used to monitor a grid-like pattern of sample sites 4 on a sample support 2 during manual preparation for determining a deposition state. To this end, transmission and reception units 22 are provided, which are arranged in rows at the sides of sample support 2, and which each transmit a test beam 24 over the surface of the sample support 2. Electromagnetic waves such as light beams can particularly be used for this purpose. In the present arrangement, reflectors 26, for example mirrors, are arranged on the respective opposite side of the sample support 2, and they reflect the test beams 24 in order that they can be received by the receivers 22 which are integrated with the transmitters. In a version which is not shown, the transmitters and receivers can be arranged separately on opposite sides. A test beam 24 would then only travel once across the sample support 2. In the present example, a grid of test beams 24 is generated whose intersections 28 all lie over the positions of the sample sites 4 on the sample support 2. If, during the preparation, a sample is now applied to a selected sample site, the test beams 24 crossing at the corresponding position are interrupted, whereas the other test beams 24 remain unaffected. The receiver units 22 preferably have a processing and evaluation function which allows the spatial assignment of the event. With this design, a deposition process on the sample support 2 can be spatially categorized and assigned to a sample site 4. The deposition state can be determined with the states DEPOSITED and NOT DEPOSITED (alternatively, deposited with a specific substance or not deposited, with matrix, analyte or solvent, for example). Additionally, an erroneous deposition can be detected in conjunction with a highlighting of a sample site if an event is detected at a location which does not correspond to the position of the highlighted sample site. Equally, a correct deposition can be confirmed.

FIG. 3b depicts an embodiment of the means for determining the deposition state of a sample site 4 which operates with an optical image of at least a partial area of the surface of the sample support 2. It has an optical sensor system 30 which comprises two adjustable cameras 32 which are aligned with their lines of sight 34 onto the surface of sample support 2 from different angles. The cameras 32 are designed to receive the light reflected from the surface, generate images from this light and transmit them to a control and processing unit 36, which communicates with the cameras 32. The sample support 2 can be illuminated with a light source (not shown) which is additionally provided. This is particularly expedient if the light for the illumination is required to have a specific spectral distribution, for example where a sample site 4 is to be illuminated for the purpose of highlighting. The image processing can thus be optimized, where necessary. It may, however, be sufficient to exploit the background light, from conventional laboratory lighting, for example. In this case no separate light source would be required.

A three-dimensional image of the sample on the sample site can be generated with the aid of images of a sample site 4 from at least two different angles. By using differences in color, brightness, contrast or combinations thereof, in particular, the state of a sample site under observation can be identified as deposited, not deposited—alternatively, deposited with a certain substance or not deposited, for example with matrix, analyte or solvent. Moreover, a three-dimensional image can be used to determine the geometric dimensions of the sample—i.e. in particular, length, width, thickness or area covered—which can be used to quantify the sample. The three-dimensional image of the sample, which was obtained, by way of an example, from the images with the aid of an imaging method is schematically depicted in the control and processing unit 36. To provide a better contrast, the neighboring sample sites are shown as unspotted in this example. In order to carry out an even more reliable identification of the deposition state, the optical sensor system 30 can also have more than two cameras. A third adjustable camera, which images the surface of the sample support, at least partially, from a different angle, is indicated by the dotted lines in the illustration.

The version shown with the cameras 32 particularly has the advantage that the deposition state of more than one sample site 4 can be simultaneously investigated. If the images taken with the cameras 32 arc visualized, they also enable quick, intuitive understanding of the recorded measurement data.

FIG. 3c depicts another embodiment of the means for determining the deposition state of a sample site 4, which operates with a scattered light measurement from the surface of the sample support 2. It has a light source 70, such as a light emitting diode. It may optionally also comprise an optical element 72, such as an imaging lens. If present the optical element 72 is preferably arranged between the light source 70 and the sample support 2 in order to focus the light 74 emitted by the diode onto a certain sample site 4 to be checked. However, if the light source 70 emits in itself well-focused light, the optical element 72 may be dispensable. The light source 70 communicates with a control system 360 and, as indicated by the double-headed arrow, may be movable and even rotatable for granting better access with the light beam 74 to all sample sites 4 on the sample support 2. Furthermore, the embodiment has a light detector 76, such as a charge-coupled device, the line of sight of which is directed towards the sample site 4 under investigation. For this purpose, the light detector 76 also communicates with the control system 360 and, as indicated by the double-headed arrow, may be movable and even rotatable in order to allow a proper alignment. The light detector 76 is preferably aligned such that, for preventing saturation effects, it does not see light emitted by the light source 70 and being reflected on the surface of the sample support 2 at the position of the sample site 4 under investigation. Instead, it is aligned such that it can detect scattered light 78 (dashed arrow) originating from the light emitted by the light source 70 and falling onto a surface modification of the sample site 4, such as a deposited sample, matrix solution and the like. To prevent background light from falling onto the light detector 76 and disturbing the detection process, the light detector 76 may optionally be equipped with a further optical element 80, such as a background light filter, arranged between the light detector 76 and the sample site 4 to be checked. It goes without saying that the light emitted by the light source 70 and the filter properties of the background light filter, for instance concerning the wavelength, should be compatible with each other in the sense that a suitable amount of scattered light may reach the light detector 76.

In various embodiments the light source 70 may emit modulated light, such as intensity-modulated light. This provides a further criterion how to differentiate light emitted from the light source 70 and ever-present background light in a laboratory, for example. The light detected by the light detector 76 may, in a post-processing, be evaluated whether the modulation is present in the detected light signal. By use of suitable signal filters, such as high-pass, band-pass or low-pass filter routines, it is possible to remove all unmodulated components of the detected light so that only the modulated light remains and background noise is effectively reduced. In certain embodiments, a modulation of the emitted light may even dispense with pre-detector filtering of background light, however, can also be used in combination therewith.

In some embodiments, the scattered light detected by the light detector 76 may be further evaluated to ascertain scattered light properties which yield further information on the scattering process. For example, a differentiation between light being scattered from a blot of biological material may look different than that scattered from a liquid layer of matrix solution on the sample site 4 or from an already crystallined matrix layer on the sample site 4. On the other hand, a very low level of scattered light in conjunction with a rather shiny polished sample support surface could indicate that there is no surface modification, such as a deposited sample, present on the sample site 4 under investigation. In this manner, it is possible to acquire additional information about the deposition state of a sample site 4.

FIG. 3d shows an embodiment similar to that presented in FIG. 3c, the difference, however, being that, apart from the scattered light 78 scattered off a sample site 4 under investigation, also the light reflected from the surface of sample site 4 under investigation is detected. As in the previous example, the embodiment has a light source 70, an optional optical element 72, a beam of light 74, an optional further optical element 80 and a light detector 76, the light source 70 and the light detector for the scattered light 76 communicating with and being controlled by a control system 360. In addition to these components, the embodiment also features a reflected light detector 82 equipped with an optional further optical element 84, such as a background light filter. The reflected light detector 82 may be movable and rotatable just as the light source 70 and the scattered light detector 76 so that proper alignment is achievable. The reflected light detector 82 is aligned along a line of sight in accordance with the optical laws of reflection, such as angle of incidence equaling angle of reflection, applicable to an at least partially reflecting surface of the sample support 2. With this alignment the reflected light detector 82 may detect light 86 (dash-dotted arrow) reflected from the surface of the sample support 2. The reflected light detector 82 also communicates with and is controlled by the control system 360. Thus, two data sets, representing the reflected light 86 and the scattered light 78, are acquired during the determination of the deposition state of a sample site 4, the data sets being complementary to one another in the sense that, when the scattered light 78 increases, for example due to biological material being deposited on the sample site 4, for instance on a sample support 2 of polished metal, the reflected light 86 tends to decrease and vice versa. This additional measure allows for the deposition state check of a sample site 4 to be even more reliable.

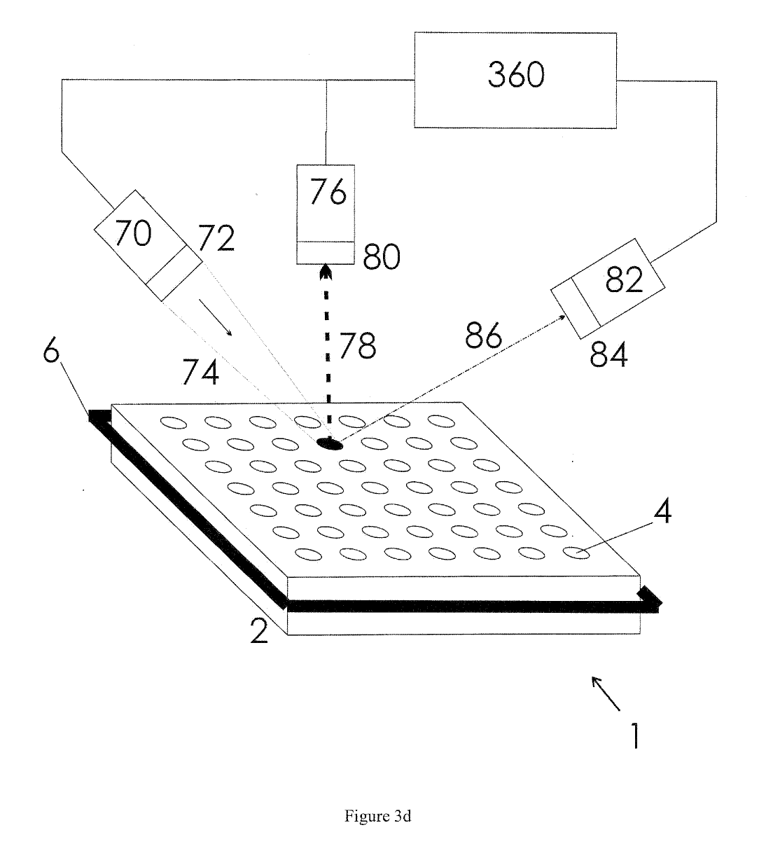

FIG. 4a is a schematic representation of how a chemo-physical property at a sample site 4—and thus at a sample—can be probed for the purpose of determining the deposition state or detecting the change to the same. Of course, the procedures for determining a deposition state described in the following, especially the probing techniques, can basically be combined in any way with the highlighting techniques described above.

An acoustic transducer 38 can be used as a probing device. This is arranged on the back of the sample support 2. A relative movement is possible between the acoustic transducer 38 and the sample support 2 in order to probe different sample sites 4. The acoustic transducer 38 can be arranged flush with the back so that a boundary surface is created, through which ultrasonic pulses can pass without significant attenuation. The ultrasonic pulses pass through the sample support 2 from the back to the surface, where they impact on a further boundary surface 40—between the surface and the applied sample 42. The ultrasonic pulse is split there into a reflected portion and a transmitted portion. The reflected portion travels back through the sample support 2 toward the acoustic transducer 38, by which it is received after passing through the boundary surface between the sample support 2 and the acoustic transducer 38 at the time t₁ (see graph on the left). The transmitted portion passes through the sample 42 until it reaches the boundary surface between the sample 42 and the surroundings (usually laboratory air). There, most of the transmitted portion is reflected and, after passing through the two boundary surfaces between the sample 42 and the sample support 2, and between the sample support 2 and the acoustic transducer 38, where it is again attenuated by further reflection and transmission processes, it arrives back at the acoustic transducer 38, which records it at the time t₂. The presence of a second ultrasonic echo at time t₂ shows that a sample 42 has been applied to the probed sample site. The time difference t₂−t₁ is, furthermore, a measure for the distance which the ultrasonic pulse has traveled in the sample 42. Taking into account the speed of the ultrasound, this can be used to determine the thickness of sample 42 as a chemo-physical property.

The thickness of the sample 42 alone can be sufficient to determine the sample quantity, if this is required or desired. FIG. 4b shows sample sites 4 on a sample support 2 which have the form of wells or cavities 44. Such sample sites are familiar from microtiter plates, for example. Since the circumferential dimensions of these wells are very accurately known, the volume of the sample can be determined from a single measurement of the sample thickness—and thus the level of sample in the well. In the drawing, one well is filled to the rim (left), whereas a second well is only around half full (right). If, for example, the crystal structure of the matrix substance used is known, the sample volume determined via the sample thickness can be used to derive the sample quantity in mass units.

In a further version, the acoustic transducer can also be used for a more detailed analysis of the sample 42. This can consist in probing the area of a sample site 4 in small, incremental steps. In other words, several propagation time measurements are carried out at one sample site, each at a slightly different position. The two-dimensional boundary contour of sample 42 can thus be determined. This means utilizing the fact that the second ultrasonic pulse peak shown in FIG. 4a is not registered at the time t₂ when an area is probed which does not contain any sample material, i.e. the acoustic transponder has moved by an incremental step away from the sample 42. At the locations where sample material is detected, the local sample thickness can be determined by the propagation time measurement. In this way, the sample area and also the volume can be determined as further chemo-physical properties of the sample 42, in addition to an uneven sample thickness, without the need for the sample sites 4 to have the shape of wells 44. The resolution, and thus the size of the incremental steps, can be selected depending on the desired accuracy, taking into account what is technically feasible. FIG. 4c illustrates the principle. There is a sample 42 (solid line) with irregular dimensions on a sample site 4 (broken line). The round elements 46 indicate incremental measuring points, which can be approached by an acoustic transducer 38, for example, in a probing sequence. The empty circles represent probing locations where no sample is detected, which therefore do not show a second pulse peak when an ultrasonic probing technique is used. The solid black circles, on the other hand, lie on the projection area of the sample 42 and will therefore create a second ultrasonic echo. This can be used to calculate a propagation time difference.

Of course, the probing principle illustrated in the FIGS. 4a to 4c, and correspondingly described with the use of an ultrasonic measurement, can also be carried out with electromagnetic waves such as light. A light source—a laser, for example, whose energy input into the sample should be limited so that no desorption is caused by the probing—and a correspondingly designed light receiver would then be used instead of the acoustic transducer 38. For light to enter from the back, the sample support 2 and the sample 42, e.g. the crystal structure of a matrix substance, would then have to be at least partially transparent. A window of transparency for light of a specific wavelength in the materials could be sufficient for this purpose. The principle of propagation time measurement to determine the sample thickness could be applied in an analogous manner, with the difference that, instead of the speed of sound, the speed of the electromagnetic waves in the solid must be used to convert the propagation times into sample thicknesses.

In one version, at least one chemo-physical property can be probed by means of spectral analysis. For this purpose, the surface of the sample support 2 can be irradiated with electromagnetic waves which have a defined spectrum. The differing reflection and absorption properties of the different materials of the sample 42, comprising matrix substance, analyte substance or solvent for example, and of the sample support 2 mean that a deposition state can be determined and, where applicable, also the sample quantity, with the aid of empirically obtained relationships. The principle of spectral analysis is illustrated in FIG. 4d in a very simple form. In this example, light with a spectral distribution which comprises two wavelengths λ₁, λ₂ falls onto the surface of the sample support 2. The different material properties of the sample and sample support produce a spectral pattern in the reflected light. In the example shown, light of both wavelengths λ₁, λ₂ is reflected equally by the sample support 2, whereas the sample 42—for example the crystal structure of a matrix substance—reflects light of wavelength λ₁ but absorbs light of wavelength λ₂, and little or nothing is reflected. The intensity differences as a function of the wavelength λ₁, λ₂ can be broken down by means of spectral analyzers arranged prior to the actual light receivers (not shown). The deposition state can be determined from the spectral distribution of the reflected light obtained in this way, and can be used to derive the sample quantity, where applicable.

Additionally, or alternatively, to the spectral analysis, the scattering behavior of electromagnetic waves which are sent to the sample or the sample site can be used for determining a chemo-physical property. Luminescence methods are also conceivable, in which case the previously described light source could be omitted. Instead, means could be used which initiate a suitable luminescent activity at the sample or at the sample site, such as fluorescence or phosphorescence. The type of excitation is preferably selected so that the sample materials, for example matrix substance, analyte substance or solvent, respond well to it. By way of non-limiting example, electroluminescence, photoluminescence and chemiluminescence are mentioned here.

FIG. 4e shows an example embodiment for probing the resonance frequency of a piezoelectric material as a chemo-physical property. For this, an oscillating crystal 48 can be used, which is integrated into the sample support 2 at the location of a sample site 4, and is coupled with the surface which is intended to hold the sample 42 on the surface of the sample support 2. The oscillating crystal 48 is excited via a lead 50, which can be supplied with voltages, to perform oscillations 52. The properties of the crystal 48 and the material coupled to it determine a characteristic resonance frequency. If the sample site 4 is deposited with a mass, this has a damping effect on the oscillatory behavior of the resonating body formed by the oscillating crystal 48 and the (deposited or not deposited) sample site 4. The resonance frequency shifts in a way which is unequivocally linked to the mass of the load. This is schematically depicted in the graph. With this embodiment, it is thus possible to not only identify a deposition state in the sense of DEPOSITED or NOT DEPOSITED, but also to quantify the corresponding sample quantity.

In the context of FIG. 4e it is understood that instead of a piezoelectric material for determining a resonance frequency, it is also possible to integrate a sensor for detecting one or more electrical or magnetic properties into the sample support 2, and this sensor can be coupled to the sample site 4 and thus with the area on the surface of the sample support 2 which is designated as sample site 4. By deposition of sample material, the electrical properties of the sample site 4 are changed by the sample material. This change in the electrical or magnetic properties can be detected with the sensor and be used to indicate the deposition state, also for the sample quantification, where applicable. Such electrical or magnetic properties can especially be the electrical capacitance, the electrical resistance, the inductance, the permittivity or the magnetizability.

FIG. 4f illustrates a further example of how a chemo-physical property can be probed. On the surface of the sample support 2 is a movable capacitance sensor 54 which can be controlled by a control and processing unit 36. In this example, the capacitance sensor 54 together with the at least partially conducting sample support material forms a capacitor whose operating mode is similar to that of a plate capacitor. The capacitance sensor 54 is moved at a defined distance across the clean and, in the unspotted state, preferably plane and smooth surface of the sample support 2. The defined separation between capacitance sensor 54 and the surface of the sample support produces a characteristic electrical capacitance, which changes if a deposited sample site is probed. If the sample 42 is also at least partially electrically conductive, it acts as a “second capacitor plate”, reducing the separation from the capacitance sensor 54, as the “first capacitor plate”. If, however, the sample 42 is not conductive, or only slightly, it assumes the properties of a dielectric between the “capacitor plates”. The resulting capacitance change can be used to determine the deposition state, and also to determine the sample thickness, where applicable. For this purpose, the relative permittivity of a crystalline matrix material, in particular, can be used if the sample has matrix material. It is, furthermore, possible to determine the sample area and sample contour from the capacitance measurements if the sample site is incrementally probed, as has already been described above in the context of a different example embodiment. Fundamentally, the probing method described in relation to FIG. 4f can also utilize the principle of electromagnetic induction. In such a case, it is preferable if the probing equipment is designed as an eddy current sensor (not shown). It is also possible to undertake the probing with a magnetic induction method, however.

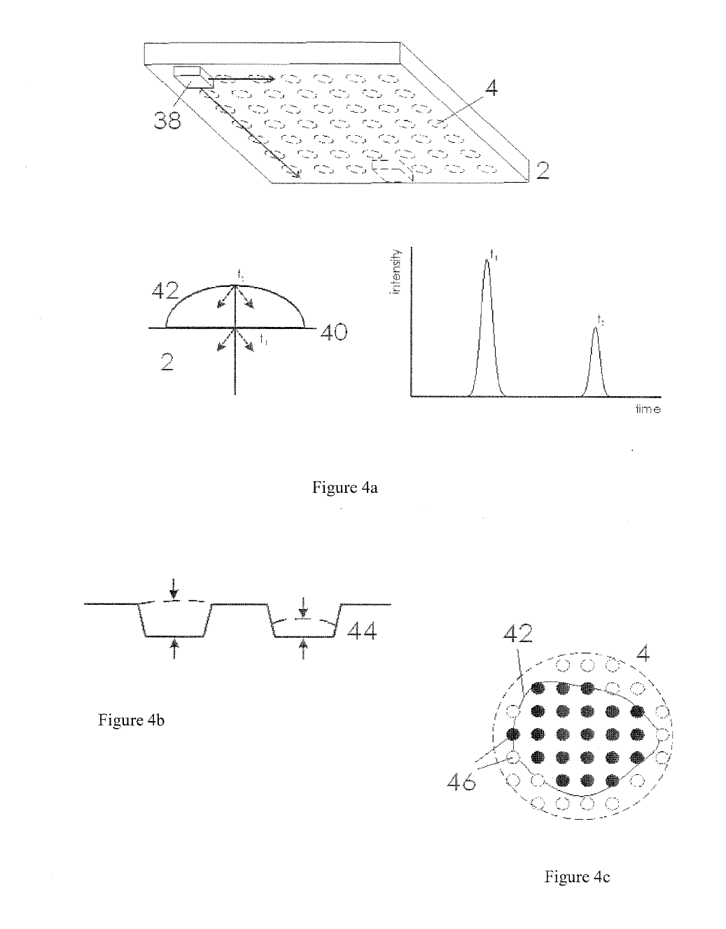

FIG. 5 shows a flow chart of an embodiment of a method to determine the deposition of a sample site on a sample support for ionization with matrix-assisted laser desorption. The first step is to deposit a sample onto a sample site. The sample site—and thus the sample—is then probed for at least one chemo-physical property. The chemo-physical property is selected from the group comprising resonance frequency of a piezoelectric material, propagation time of ultrasonic or electromagnetic waves, electrical capacitance, electrical resistance, inductance, permittivity, magnetizability, light diffusion, light absorption, light reflection or luminescence. The deposition state of the sample site is finally determined on the basis of a change in at least one chemo-physical property.

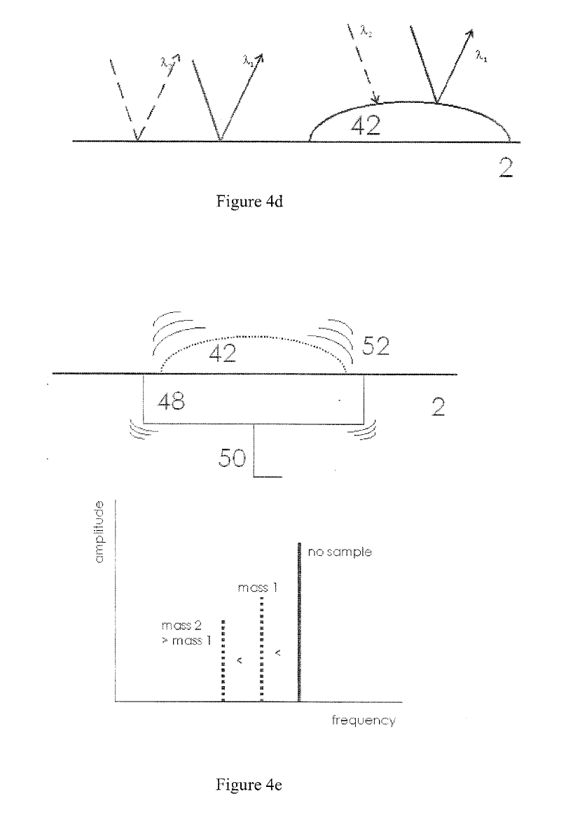

FIG. 6 shows a flow chart of an embodiment of a method to determine the sample quantity which is deposited on a sample site of a sample support for ionization with matrix-assisted laser desorption. The first step is to deposit a sample onto a sample site. The three-dimensional distribution of this sample is then determined by an optical surface-measuring technique. The optical surface-measuring technique is taken from the group comprising holography, interferometry, speckle-pattern interferometry, fringe projection, laser triangulation or laser scanning. The sample quantity can be calculated if the three-dimensional distribution of the sample and its density properties, which are particularly characterized by the matrix material, are known.

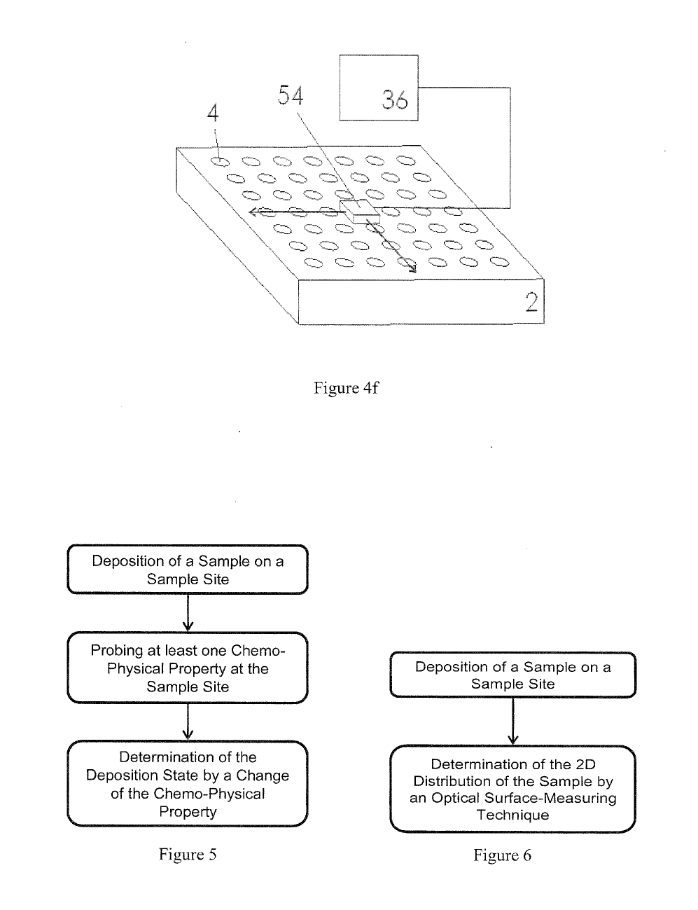

FIG. 7 is a schematic representation of a probing of a sample 42 on a sample site 4. This probing method uses the intensity and phase information. For this purpose, two beams 56, 58 are made to interfere. In order to create precise interference patterns, the use of coherent electromagnetic waves is preferred. These are usually provided in the form of a laser beam 60 expanded by means of divergent lenses. A beam splitter 62 produces two partial beams, one of which is directed as the probing beam 56 onto the sample 42 or the sample site 4. The other partial beam 58 is deflected and reaches a detector 64 together with the probing beam 56 which is reflected from the sample site 4. The detector 64 can thus detect not only the intensity, but also the extinction pattern of the beams 56, 58 which interfere with each other. By moving the sample support 2 with the sample sites 4 relative to the measuring setup, the sample 42 or the sample site 4 can be probed from different angles. With knowledge of the arrangement of the sample site 4, the deflection unit 66 and the detector 64, a three-dimensional image of the sample 42 probed in this way, and thus the probed sample site 4, can be generated, and the three-dimensional distribution of the sample 42 on the sample site 4, if present, can be determined. The distribution or the image indicates the deposition state. The image or distribution information thus obtained can also be used to determine the sample quantity. The principle described above, with modifications where necessary, can be carried out as: holography or interferometry, particularly speckle-pattern interferometry. In addition to interferometric methods, the methods which are known as fringe projection, laser triangulation and laser scanning can also be used to determine the three-dimensional distribution of a sample 42.

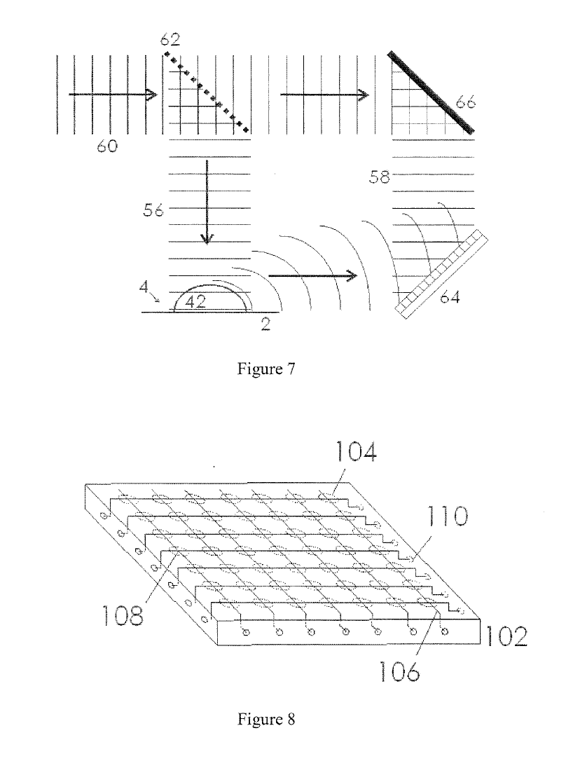

FIG. 8 shows a sample support 102 which is suitable for determining the deposition state of a sample site 104 in a particular way. On the surface, where the sample sites 104, i.e. the locations where a sample is to be deposited, are marked by circles, electrical conductors 106 in the form of wires are integrated into the sample support 102. They cross the surface in two directions which are approximately at right angles to each other (although this is not mandatory). The intersections 108 of the electrical conductors 106 are each located at the position of a sample site 104. If a sample site 104 is spotted with a sample, the sample material, for example a matrix substance, analyte substance or a solvent, comes into contact with the electrical conductors 106 and changes the electrical properties, such as the electrical resistance. By applying test currents or test voltages, for example via the connections 110 on the narrow sides of the sample support 102, the grid of electrical conductors can be monitored. If the characteristic signals indicating a deposition appear in the test current or test voltage pattern, the location of the change or the event can be identified in the matrix of the intersections 108 of the electrical conductors 106. In the example shown, an intersection 108 is assigned to each sample site 104. It is understood that the sensor grid can also be designed in such a way that more than one intersection 108 is assigned to one sample site 104. The sample support 102 is preferably provided with a holder (not shown) which has the matching complementary connections for the connection points 110 on the sample support 102.

Additionally, or alternatively, to the electrical conductors 106, a grid of induction sensors, photo-sensors or oscillating crystals (none of them shown) can be integrated into the sample support 102. A power source (not shown) can also be incorporated as an integral part of the sample support 102. The integrated design of the sample support 102 with sensors means that all sensor methods have the advantage of a very small space requirement. This provides design freedom for the instruments possibly arranged above the sample support 102 for deposition and/or examining the sample support. The sample support 102 can also have an interface for data input and/or data output (not shown).

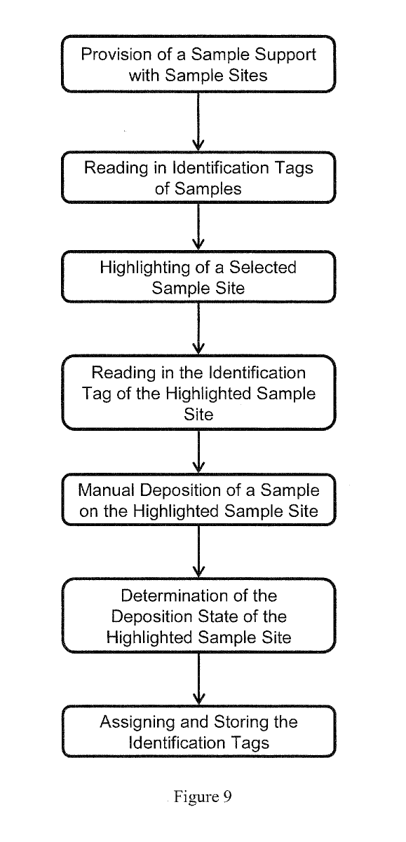

FIG. 9 shows a flow chart of an embodiment of a method according to the invention whereby the identification tags are stored. A sample support with sample sites is provided. This can be a MALDI sample support with 384 sample sites, for example. Furthermore, a flat nutrient medium in which microbe colonies have grown is provided, for example a Petri dish. Agar plates or pellets obtained by centrifugation or filtration can also serve as flat sources of samples. The sample vessel can be provided with a barcode as the identification tag, which is read in by optical probing, for example. Additionally, or alternatively, it would also be possible to have an RFID chip as the carrier of an identification tag, which could then be read out via wireless signal. The arrangement of the colonies on the nutrient medium can be photographed with a camera and evaluated with regard to the exact positioning of the individual colonies, for example with respect to the XY-coordinates of the individual colonies on the flat nutrient medium. With this information, the identification tag of the nutrient medium carrier can be supplemented per sample or colony, and thus specified in more detail.

A selected sample site is highlighted. An identification tag of the highlighted sample site is read in so that it can subsequently be assigned to the sample origin. A sample is deposited manually by a technician on the highlighted sample site. After determining the deposition state of the highlighted sample site, the identification tags can be assigned to each other and stored on a suitable storage medium, particularly in an electronic memory. The sequence of reading in the identification tag and the assignment and storage in the method of sample preparation as presented is to be understood as an example. In one version, the identification tag of the highlighted sample site can be read in after the deposition. The order of the method steps shown here is not to be understood as limiting in this respect.

1. Method to assist with the manual preparation of a sample support for ionization with matrix-assisted laser desorption, wherein:
(a) a sample support with sample sites is provided;
(b) a control system acquires a configuration of the sample support with the sample sites;
(c) the control systems initiates highlighting a selected sample site at least with respect to neighboring, not selected sample sites in a way which is visible to the human eye;
(d) a sample is manually deposited onto the selected and highlighted sample site; and
(e) the control systems initiates a determination of a deposition state of at least the selected and highlighted sample site and compares it with a target deposition state of the selected and highlighted sample site.

2. Method according to claim 1, wherein the selected sample site is highlighted mechanically or with the aid of a light effect.

3. Method according to claim 1, wherein the highlighting of the selected and highlighted sample site is ended when a change in the deposition state of the selected and highlighted sample site is identified.

4. Method according to claim 1, wherein a notification or warning signal is generated if a change in the deposition state at a location other than the selected and highlighted sample site is identified or if a predetermined time has elapsed since the start of the highlighting without a deposition state change being detected.

5. Method according to claim 1, wherein the deposition state is determined with the aid of an optical sensor system which has a processing and evaluation function, whereby changes are detected and spatially assigned.

6. Method according to claim 1, wherein the deposition state is determined with the aid of a two- or three-dimensional optical image.

7. Method according to claim 1, wherein at least one chemo-physical property is probed at one sample site from the total number of sample sites, and the deposition state is determined by means of a change in at least one chemo-physical property, the chemo-physical property being taken from the group comprising resonance frequency of a piezoelectric material, density, geometric dimension, propagation time of ultrasonic or electromagnetic waves, electrical capacitance, electrical resistance, inductance, permittivity, magnetizability, light diffusion, light absorption, light reflection, light scattering or luminescence.

8. Method according to claim 6, wherein the sample quantity is determined from at least one chemo-physical property, from the optical image, or from both, and a notification or warning signal is generated if the sample quantity does not correspond to a predetermined target sample quantity.

9. Method of manual preparation of a sample on a sample support for ionization with matrix-assisted laser desorption where a sample to which an identification tag is assigned is provided, a sample site on the sample support which has another identification tag is highlighted using a method in accordance with claim 1, a sample is deposited on the highlighted sample site, and the identification tags are assigned to each other and stored.

10. Method according to claim 9, wherein the identification tag of the sample is derived from the labeling of the sample vessel from which the sample originates.

11. Method for determining a deposition state of a sample site on a sample support for ionization with matrix-assisted laser desorption, wherein, after a sample has been deposited, at least one chemo-physical property is probed at the sample site, and the deposition state is determined by means of a change in at least one chemo-physical property, the chemo-physical property being taken from the group comprising resonance frequency of a piezoelectric material, propagation time of ultrasonic or electromagnetic waves, electrical capacitance, electrical resistance, inductance, permittivity, magnetizability, light diffusion, light absorption, light reflection, light scattering or luminescence.

12. Method for determining a sample quantity deposited on a sample site of a sample support for ionization with matrix-assisted laser desorption, wherein a three-dimensional distribution of a sample deposited on the sample site is determined by at least one of the following optical surface-measuring techniques: holography, interferometry, speckle-pattern interferometry, fringe projection, laser triangulation or laser scanning.

13. Method according to claim 1, wherein the sample comprises a solution with a matrix substance, crystals of a matrix substance, cells of a microorganism or several microorganisms, dissolved cell components of a microorganism or several microorganisms, or any combination of these.

14. Sample support for ionization with matrix-assisted laser desorption, wherein a sensor for a chemo-physical property is integrated at a sample site of the sample support.

15. Sample support according to claim 14, wherein the sensor detects the resonance frequency of a piezoelectric material, the electrical capacitance, the electrical resistance, the inductivity, the magnetizability, the light diffusion, the light absorption, the luminescence or any combination thereof.

16. Sample support according to claim 14, wherein the sensor is a transistor, a resistor in a Wheatstone bridge, a resistor of a resistance grid, a quartz microbalance, a photosensor, a pressure sensor as used in touchscreens, or any combination thereof.
